(19) United States
(12) Patent Application Publication
(10) Pub. No.: US 2009/0157549 A1
(43) Pub. Date: Jun. 18, 2009

(54) USING A MOBILE PHONE AS A REMOTE PIN ENTRY TERMINAL FOR CNP CREDIT CARD TRANSACTIONS

(76) Inventor: Benjamin Ian Symons, Southport (AU)

Correspondence Address: IBM CORP (YA);C/O YEE & ASSOCIATES PC, P.O. BOX 802333, DALLAS, TX, 75380, US

(21) Appl. No.: 11/957,077

(22) Filed: Dec. 14, 2007

(51) Int. Cl. G06Q 40/00

(52) U.S. Cl. 705/44

(57) ABSTRACT

A computer implemented method, computer program product, and data processing system for authorizing a financial transaction with an account. A request to perform the financial transaction with the account is received. The financial transaction is authorized responsive to receiving a pre-determined code from a mobile communication device associated with a user who has authority to authorize the financial transaction.

### BACKGROUND OF THE INVENTION

1. Field of the Invention

The present invention relates generally to an improved data processing system and in particular to improved security systems for credit card transactions.

2. Description of the Related Art

Credit card fraud costs businesses and individuals billions of dollars each year. Thus, devices and methods for reducing or hampering credit card fraud are constantly sought. Some devices and methods for combating credit card fraud have been implemented.

For example, PAYPAL® provides a method of transferring funds between individuals. This service requires that a separate account be setup with PAYPAL® before transactions can be made. This service does not work well with telephone orders.

In another example, pre-paid credit cards can be purchased and used. Indirectly, security is increased by limiting the amount of credit associated with the account number of the pre-paid credit card. However, additional overhead is associated with each card purchased or issued, and a fee is charged for each card purchased.

In another example, a three-digit “security code” is often printed on the back of a credit-card. The three-digit code can be required for internet or phone transactions. However, if the credit card itself is stolen, then this security measure provides no protection against fraud.

### SUMMARY OF THE INVENTION

The illustrative embodiments provide for a computer implemented method, computer program product, and data processing system for authorizing a financial transaction with an account. A request to perform the financial transaction with the account is received. The financial transaction is authorized responsive to receiving a pre-determined code from a mobile communication device associated with a user who has authority to authorize the financial transaction.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems, in which illustrative embodiments may be implemented;

FIG. 2 is a block diagram of a data processing system, in which illustrative embodiments may be implemented;

FIG. 3 is a block diagram illustrating a secured credit card transaction, in accordance with an illustrative embodiment;

FIG. 4 is a flowchart of a process for authorizing a secured credit card transaction, in accordance with an illustrative embodiment;

FIG. 5 is a flowchart of a process for authorizing a secured credit card transaction, in accordance with an illustrative embodiment;

FIG. 6 is a flowchart of a process for authorizing a client-side secured credit card transaction, in accordance with an illustrative embodiment; and

FIG. 7 is a flowchart of a process for authorizing a server-side secured credit card transaction, in accordance with an illustrative embodiment.

### DETAILED DESCRIPTION OF THE PREFERRED EMBODIMENT

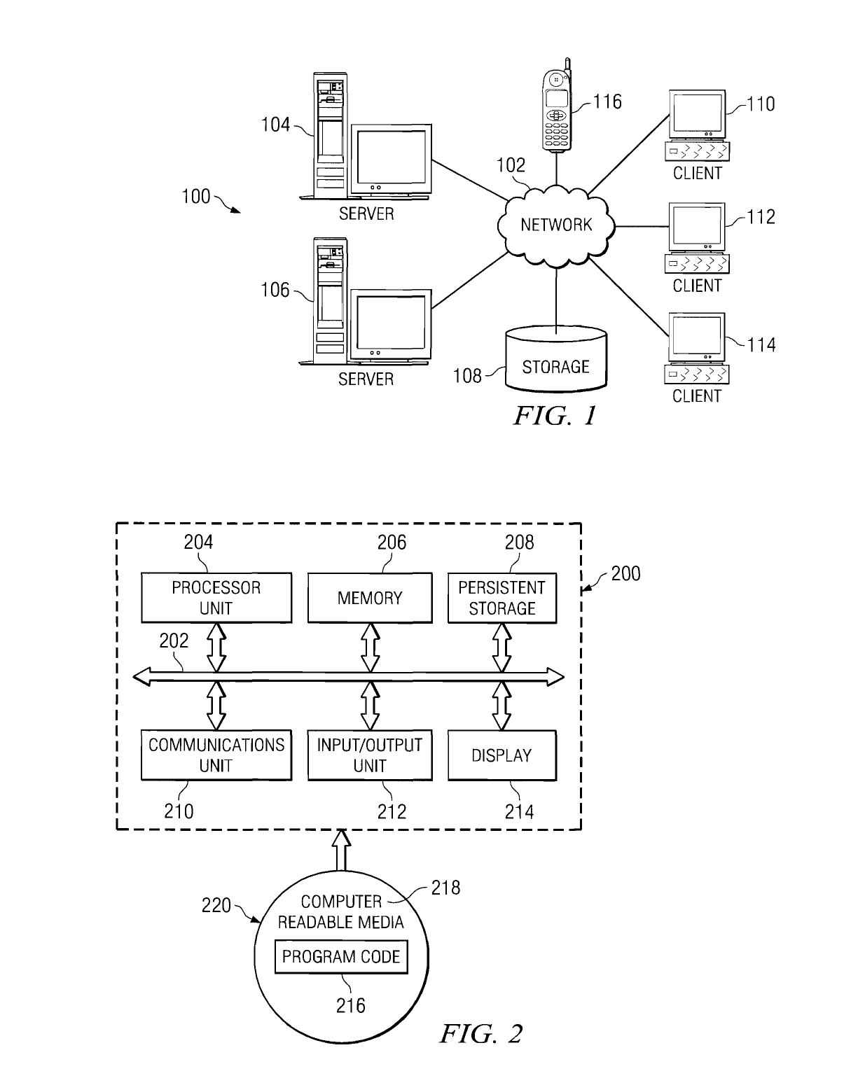

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Additionally, mobile communication device 116 can connect to network 102, transmitting telecommunications signal, connectionless datagrams, and/or other forms of data between any of servers 104 or 106; clients 110, 112, or 114; or storage 108. Mobile communication device 116 can be a cellular phone, mobile phone, Apple® iPhone®, personal digital assistant, or any other mobile communications device. Network data processing system 100 may include additional servers, clients, mobile communication devices, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments take advantage of speed and other technical advances in mobile communications technology. Specifically, the illustrative embodiments provide for a computer implemented method, computer program product, and data processing system for authorizing a financial transaction with an account. A request to perform the financial transaction with the account is received. For purposes of this document, a request to authorize the financial transaction can be considered a request to perform the financial transaction. The financial transaction is authorized responsive to receiving a pre-determined code from a mobile communication device associated with a user who has authority to authorize the financial transaction.

FIG. 3 is a block diagram illustrating a secured credit card transaction, in accordance with an illustrative embodiment. The secured credit card transaction could also be any other form of financial transaction that involves a financial account associated with customer 300, merchant 302, payment processor 304, and bank 306.

Normally, credit card transactions are conducted as follows. Customer 300 presents merchant 302 with a credit card or credit card number, along with a request to purchase goods and/or services. Merchant 302 then requests that funds be transferred from the credit account of customer 300 to an account belonging to merchant 302. Normally, this request is made to payment processor 304, which then forwards the request to bank 306.

Bank 306 manages the credit account belonging to customer 300. Bank 306 need not be a bank, but can be any financial or other institution that manages the financial account associated with the mobile communication device of customer 300. The mobile communication device is considered “associated with” the account if the mobile communication device has been registered as a device belonging to the owner or other entity associated with the account.

Note that in some instances, payment processor 304 is not needed; in this case, merchant 302 directly requests authorization to conduct the transaction between bank 306 and the financial institution of merchant 302.

If sufficient funds are available in the credit account of customer 300, and assuming merchant 302 still desires to complete the transaction, authorization is granted and funds are transferred as requested (again, through payment processor 304). Otherwise, authorization is denied.

However, the illustrative embodiments recognize the advantages present in faster and more advanced mobile communications devices. In one illustrative embodiment, the security of the credit card transaction described above can be enhanced through the use of a mobile communication device of customer 300.

Specifically, in response to payment processor 304 or merchant 302 requesting authorization to charge the credit account, a secure Web server of bank 306 transmits a link to a secure web page to the mobile communication device associated with customer 300. The mobile communication device is considered “associated with” customer 300 if the mobile communication device has been registered with bank 306 as a device to which this link can be sent.

Customer 300 then follows the link using the mobile communication device. The link directs the customer to a secure web page. Specifically, when the customer activates the link, the secure Web server transmits a new web page to the mobile communication device. The new page contains a prompt for customer 300 to enter a pre-determined code.

The pre-determined code can be a personal identification number (PIN), a string of alpha-numeric characters, a sequence of buttons or images to select (the images or buttons contained in the secure Web page) or any other code. The pre-determined code can be subdivided into multiple codes that have to be entered in sequence. One such component of multiple codes could be agreed between merchant 302 and Customer 300 to allow merchant 302 even greater confidence in accepting the transaction. Additionally, the pre-determined code can also be biometric information, such as retinal scans, fingerprint information, possibly even DNA information, which the mobile communication device can receive from customer 300 just before transmission to bank 306.

The authorization can also be a two step process. In the first step, customer 300 enters the initial pre-determined code to prove the identity of customer 300. In the second step, customer 300 enters a second code to cause the secure Web server to transmit additional information, transmit any further pre-determined authorization codes required by the merchant, payment processor or others, and prompt customer 300 to confirm the transaction. This two-step authorization process would further protect the privacy of the customer 300 by allowing viewing of private information only after providing the correct pre-determined code.

If the pre-determined code is entered correctly and successfully transmitted to the secure web server of bank 306, then bank 306 authorizes the transaction. If payment processor 304 is being used, then the authorization is transmitted to payment processor 304 and thence to merchant 302. Otherwise, authorization is transmitted directly to merchant 302.

If the pre-determined code is entered incorrectly or is not successfully transmitted, then the authorization is denied. Additionally, the secure web page can contain a button or other prompt to indicate a desire by customer 300 to cancel the transaction. If customer 300 cancels the transaction by transmitting the appropriate input to the secure web server, then authorization is denied.

This process can be performed using a web browser loaded onto the mobile communication device. For example, a mobile phone can display the secure web page using the web browser, and customer 300 can interact with the secure web page using the mobile communication device as an input device. Thus, for example, the link can be a link to a URL of the secure web page accessed via the Internet. The URL can contain a randomized path, or can be dynamically generated upon receipt of the request, in order to prevent URL guessing. The connection to the secure web server should be encrypted to prevent interception by third parties. The URL can also expire after a predetermined time period which should be relatively short, such as five minutes. The URL can be sent via SMS, MMS, email, push technology, an embedded SIP agent, or any other means for quickly transmitting the URL to the mobile communication device of customer 300.

To further enhance security, bank 306 could require that a personal certificate (or digital ID) be supplied by the Web browser on the mobile communication device when connecting to the secure Web server. This personal certificate should be created, and signed, by bank 306. In other words, bank 306 acts as the certificate authority for the personal certificate. Bank 306 also distributes the personal certificate to the mobile communication device when the security service of the illustrative embodiments is setup.

The personal certificate can be revoked if customer 300 loses the associated mobile communication device or is concerned that the personal certificate is compromised. To further enhance security, the personal certificate should expire after a time, which can be a pre-determined time such as six to twelve months. Expiration of the personal certificate further reduces the likelihood of fraud where customer 300 passes ownership of the mobile communication device to another person and neglects to request bank 306 to revoke the certificate. In this illustrative example, bank 306 would create and distribute new personal certificates to customer 300 on a regular basis.

The mobile communication device can also be any other form of communication device, such as a personal digital assistant (PDA), mobile laptop computer, or any other form of communication device that is readily hand portable. In another illustrative embodiment, the mobile communication device can be replaced with a desktop computer or some other device that is not readily hand portable, or that is locked down to a particular location. This embodiment further increases security at the expense of portability.

Thus, the illustrative embodiments dramatically increase security of credit account transactions, including credit card transactions. A potential embezzler would have to obtain the mobile communication device and also know or be able to access the pre-determined code in order to conduct a transaction with respect to the credit account of customer 300.

In another illustrative embodiment, whenever bank 306 receives a request for authorization to conduct a financial transaction with respect to an account of customer 300, the secure Web server of bank 306 can also transmit information about the transaction to the mobile communication device of customer 300. Examples of information about the transaction include but are not limited to the amount of the transaction, the goods and/or services to be purchased, the name of the merchant, vendor, or other entity requesting the authorization, the time of the requested authorization, and combinations thereof. Additionally, information about the transaction can be transmitted responsive to pre-conditions set by one of bank 306, customer 300, or both. For example, if the monetary amount of the transaction exceeds a pre-determined value, then the secure Web server can transmit information about the transaction to the mobile communication device of customer 300. Still further, the amount or type of information about the transaction transmitted can be responsive to pre-conditions set by one of bank 306, customer 300, or both. For example, if the dollar amount of the transaction is below a certain number, then only the dollar amount is transmitted to the mobile communication device of customer 300. However, if the dollar amount of the transaction is above a certain number, or if the transaction takes place within pre-determined time period, then additional information is transmitted to the mobile communication device of customer 300, such as the name of the entity requesting authorization and/or the location at which authorization was requested.

FIG. 4 is a flowchart of a process for authorizing a secured credit card transaction, in accordance with an illustrative embodiment. The process shown in FIG. 4 can be implemented in one or more data processing systems, such as clients 110, 112, or 114, and servers 104 or 106 of FIG. 1, or data processing system 200 of FIG. 2. The process can be conducted over a network, such as network 102 of FIG. 1. The process shown in FIG. 4 is an illustrative example of processes that can be conducted according to the block diagram shown in FIG. 3.

The process begins as the customer places an order, providing credit information to a merchant (step 400). The merchant then contacts a payment processor, providing credit information and a request to the payment processor to authorize the transaction (step 402). The payment processor then contacts the bank, providing the credit information and the request for authorization to the bank (step 404).

The bank then makes a determination whether both the credit account is valid and sufficient credit is available (step 406). If either the credit account is not valid or insufficient credit is available, a “no” determination to step 406, then a “not authorized” message is transmitted to the payment processor (step 408). The payment processor then returns the “not authorized” message to the merchant (step 410). The process terminates thereafter.

However, if both the credit account is valid and sufficient credit is available, a “yes” determination to step 406, then the bank sends a message to the customer's mobile communication device with a link to a secure web server (step 412). The customer then accesses the secure web server with the mobile communication device (step 414). The mobile communication device receives data describing the transaction (step 416). Examples of such data include information about the transaction, such as described with respect to FIG. 3.

The mobile communication device then displays the data and prompts the customer to enter a personal identification (PIN) number or some other code (step 418). The mobile communication device then transmits the customer's response back to the secure web server of the bank (step 420).

The secure web server then determines whether the customer has both entered the correct personal identification number and has not canceled the transaction (step 422). If the customer does not enter the correct personal identification number or cancels the transaction, a “no” determination to step 422, then the process returns to step 408 and proceeds to termination. However, if the customer successfully enters the correct personal identification number and does not cancel the transaction, a “yes” determination to step 422, then the bank transmits an “authorized” message to the payment processor (step 424). The payment processor then returns the “authorized” message to the merchant (step 426).

The illustrative embodiments do not preclude bank 306 of FIG. 3 from implementing other options relating to the denial of authorization. For example, like most teller machines that allow three attempts to enter the correct PIN code before canceling the transaction, bank 306 of FIG. 3 could configure their secure Web service to also allow the customer only a pre-determined number of attempts to enter one or more codes. After the pre-determined number of attempts is used, bank 306 of FIG. 3 can cancel the transaction. Similarly, like some teller machines that hold a credit card or automated teller machine card after three incorrect code entry attempts, bank 306 of FIG. 3 could place temporary restrictions on the use of the financial account after a pre-determined number of failed attempts to enter one or more code.

The merchant then decides whether to accept the transaction (step 428). If the merchant refuses the transaction, a “no” determination to step 428, then the transaction is canceled (step 430). If the merchant accepts the transaction, a “yes” determination to step 428, then the transaction is processed (step 432), and the customer's account is credited or debited accordingly. In either case, after step 430 or 432, the process terminates thereafter.

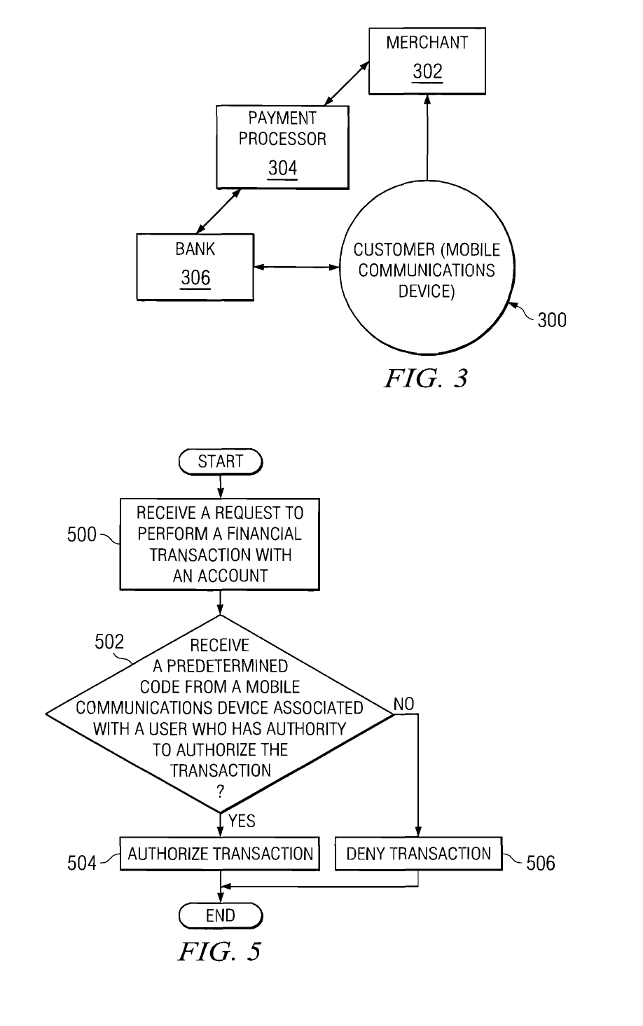

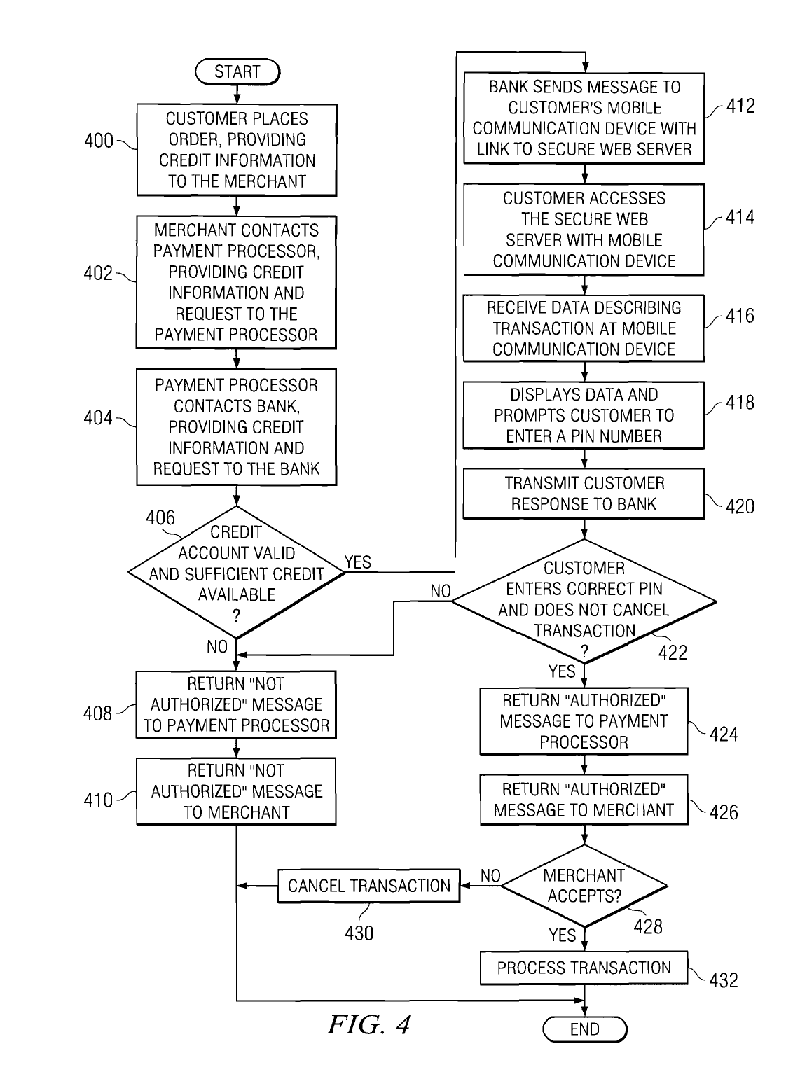

FIG. 5 is a flowchart of a process for authorizing a secured credit card transaction, in accordance with an illustrative embodiment. The process shown in FIG. 5 can be implemented in one or more data processing systems, such as clients 110, 112, or 114, or servers 104 or 106 of FIG. 1, or data processing system 200 of FIG. 2. The process can be conducted over a network, such as network 102 of FIG. 1. The process shown in FIG. 5 is an illustrative example of processes that can be conducted according to the block diagram shown in FIG. 3. The process shown in FIG. 5 can be performed by a secure web server of a financial institution.

The process begins as the secure web server, or other data processing system of an institution managing the financial account, receives a request to perform a financial transaction with an account (step 500). The secure web server then determines whether a predetermined code is received from a mobile communication device associated with a user who has authority to authorize the transaction (step 502). If the predetermined code is received, a “yes” determination to step 502, then the secure web server authorizes the transaction (step 504). However, if the predetermined code is not received or is incorrect, a “no” determination to step 502, then the secure Web server denies the transaction (step 506). In either case, after step 504 or 506, the process terminates thereafter.

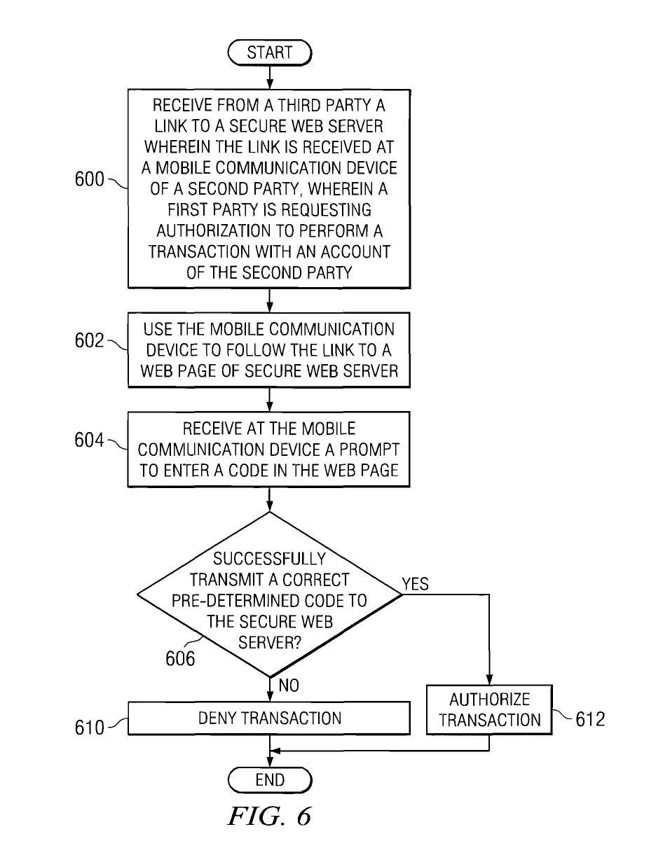

FIG. 6 is a flowchart of a process for authorizing a client-side secured credit card transaction in accordance with an illustrative embodiment. The process shown in FIG. 6 can be implemented in one or more data processing systems, such as clients 110, 112, or 114 of FIG. 1, or data processing system 200 of FIG. 2. The process can be conducted over a network, such as network 102 of FIG. 1. The process shown in FIG. 6 is an illustrative example of processes that can be conducted according to the block diagram shown in FIG. 3. The process shown in FIG. 6 can be performed by a mobile communication device of a customer, such as customer 300 of FIG. 3.

The process begins as a mobile communication device of a second party receives from a third party a link to a secure Web server, wherein a first party is requesting authorization to perform a transaction with an account of the second party (step 600). The mobile communication device is then used to follow the link to a web page of a secure web server (step 602). Additionally, the mobile communication device receives a prompt to enter a code in the web page (step 604).

A determination is then made whether the mobile communication device successfully transmits a correct pre-determined code to the secure web server (step 606). If the correct pre-determined code is transmitted to the secure Web server, a “yes” determination to step 606, then the transaction is authorized (step 608). However, if either transmission is not successful or the pre-determined code is not correct, a “no” determination to step 606, then the transaction is denied (step 610). The process terminates after either step 608 or 610.

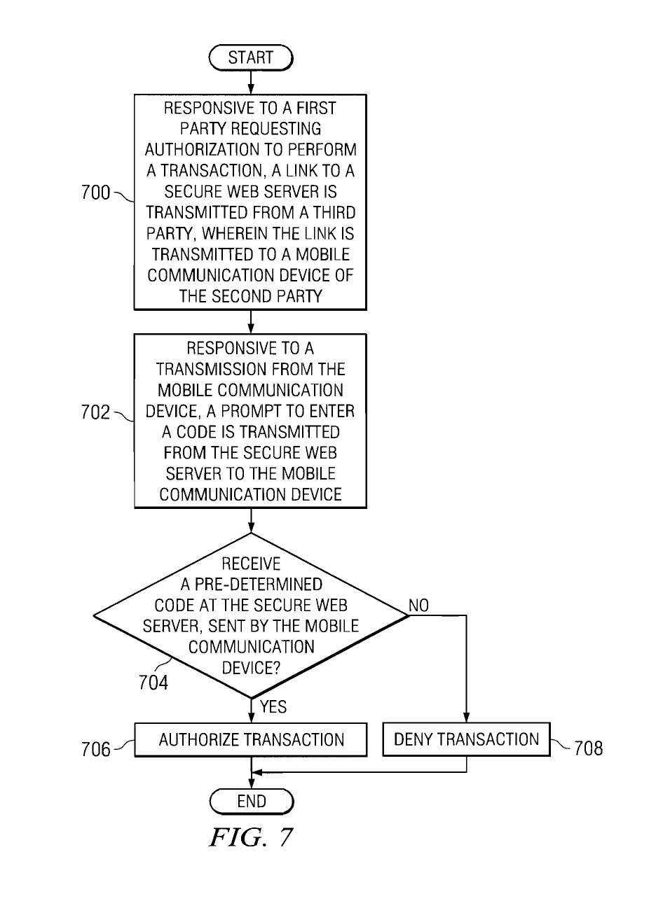

FIG. 7 is a flowchart of a process for authorizing a server-side secured credit card transaction, in accordance with an illustrative embodiment. The process shown in FIG. 7 can be implemented in one or more data processing systems, such as servers 104 or 106 of FIG. 1, or data processing system 200 of FIG. 2. The process can be conducted over a network, such as network 102 of FIG. 1. The process shown in FIG. 7 is an illustrative example of processes that can be conducted according to the block diagram shown in FIG. 3. The process shown in FIG. 7 can be performed by a secure Web server of a financial institution.

The process begins as, responsive to a first party requesting authorization to perform a transaction, a link to a secure web server is transmitted from a third party, wherein the link is transmitted to a mobile communication device of the second party (step 700). Next, responsive to a transmission from the mobile communication device, a prompt to enter a code is transmitted from the secure Web server to the mobile communication device (step 702).

The secure web server then determines whether it receives a pre-determined code from the mobile communication device (step 704). If the pre-determined code is received at the secure web server, a “yes” determination to step 704, then the transaction is authorized (step 706). However, if the pre-determined code is not received at the secure web server, a “no” determination to step 704, then the transaction is denied (step 708). The transaction can be authorized or denied by the secure web server, by a payment service, or by some other data processing system. In either case, after either step 706 or 708, the process terminates.

Thus, the illustrative embodiments provide for a computer implemented method, computer program product, and data processing system for authorizing a financial transaction with an account. A request to perform the financial transaction with the account is received. The financial transaction is authorized responsive to receiving a pre-determined code from a mobile communication device associated with a user who has authority to authorize the financial transaction.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by, or in connection with, a computer or any instruction execution system. For the purposes of this description, a computer-usable or computer readable medium can be any tangible apparatus that can contain, store, communicate, propagate, or transport the program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of authorizing a financial transaction with an account, the computer implemented method comprising:
receiving a request to perform the financial transaction with the account; and
responsive to receiving a pre-determined code from a mobile communication device associated with a user who has authority to authorize the financial transaction, authorizing the financial transaction.

2. The computer-implemented method of claim 1 further comprising:
responsive to receiving the request, transmitting information about the financial transaction to the mobile communication device.

3. The computer-implemented method of claim 1 further comprising:
responsive to receiving one of a second code different than the predetermined code and a request to cancel the financial transaction, denying the financial transaction.

4. The computer-implemented method of claim 1 wherein the financial transaction comprises a credit card transaction.

5. The computer-implemented method of claim 1 wherein the pre-determined code is transmitted from the mobile communication device by the user inputting the pre-determined code in a Web page transmitted to the mobile communication device by a secure Web server.

6. The computer-implemented method of claim 1 wherein the pre-determined code comprises biometric information received at the mobile communication device.

7. The computer-implemented method of claim 1 wherein the predetermined code further comprises a second pre-determined code entered separately from the pre-determined code.

8. The computer-implemented method of claim 7 wherein the second pre-determined code is entered by a merchant, wherein the merchant is requesting the financial transaction.

9. A computer-implemented method of authorizing a transaction between a first party and a credit account associated with a second party, wherein the credit account is managed by a third party, the computer-implemented method comprising:
responsive to the first party requesting authorization to perform the transaction, receiving from the third party a link to a secure Web server, wherein the link is received at a mobile communication device of the second party;
using the mobile communication device to follow the link;
responsive to following the link, receiving at the mobile communication device a prompt to enter a code; and
responsive to both correctly entering a predetermined code at the mobile communication device and also successfully transmitting the predetermined code from the mobile communication device to the secure Web server, authorizing the transaction.

10. The computer-implemented method of claim 9 further comprising:
responsive to following the link, receiving and displaying, at the mobile communication device, information about the transaction.

11. The computer-implemented method of claim 9 further comprising:
responsive to one of incorrectly entering the predetermined code and transmitting a request to cancel the transaction, denying the transaction.

12. A computer-implemented method of authorizing a transaction between a first party and a credit account associated with a second party, wherein the credit account is managed by a third party, the computer-implemented method comprising:
responsive to the first party requesting authorization to perform the transaction, transmitting from the third party a link to a secure Web server, wherein the link is transmitted to a mobile communication device of the second party;
responsive to a transmission from the mobile communication device, transmitting from the secure Web server to the mobile communication device a prompt to enter a code; and
responsive to receiving at the secure Web server a predetermined code transmitted by the mobile communication device, authorizing the transaction.

13. The computer-implemented method of claim 12 further comprising:
responsive to the transmission, transmitting information about the transaction from the secure Web server to the mobile communication device.

14. The computer-implemented method of claim 12 further comprising:
responsive to receiving of one of a second code different than the predetermined code and a request to cancel the transaction, denying the transaction.

15. A recordable-type medium containing a computer program product for authorizing a financial transaction with an account, the computer program product comprising:
instructions for receiving a request to perform the financial transaction with the account; and
instructions for responsive to receiving a pre-determined code from a mobile communication device associated with a user who has authority to authorize the financial transaction, authorizing the financial transaction.

16. The recordable-type medium of claim 15 wherein the computer program product further comprises:
instructions for, responsive to receiving the request, transmitting information about the financial transaction to the mobile communication device.

17. The recordable-type medium of claim 15 wherein the computer program product further comprises:
instructions for, responsive to receiving one of a second code different than the predetermined code and a request to cancel the financial transaction, denying the financial transaction.

18. The recordable-type medium of claim 15 wherein the pre-determined code is transmitted from the mobile communication device by the user inputting the pre-determined code in a Web page transmitted to the mobile communication device by a secure Web server.

19. The recordable-type medium of claim 15 wherein the pre-determined code comprises biometric information received at the mobile communication device.

20. The recordable-type medium of claim 15 wherein the predetermined code further comprises a second pre-determined code entered separately from the pre-determined code and wherein the second pre-determined code is entered by a merchant, wherein the merchant is requesting the financial transaction.
